(19) United States
(12) Patent Application Publication
(10) Pub. No.: US 2018/0300654 A1
(43) Pub. Date: Oct. 18, 2018

(54) REVENUE GENERATING INTELLIGENT SYSTEM

(71) Applicant: GENERAL ELECTRIC COMPANY, Schenectady, NY (US)

(72) Inventors: Himamshu Viswat PRASAD, East Cleveland, OH (US); David Austin ASHE, East Cleveland, OH (US)

(21) Appl. No.: 15/490,039

(22) Filed: Apr. 18, 2017

(51) Int. Cl. G06Q 10/02; G07B 15/00; G08G 1/14

(52) U.S. Cl. CPC G06Q 10/02; G08G 1/141; G07B 15/00

(57) ABSTRACT

Provided is a parking reservation method including monitoring a parking area, via a sensor, to (i) determine movement within the parking area and (ii) produce movement data representative of the movement. The method also includes analyzing the movement data, via a processor, to create a user alert and transmitting the alert to a user external device.

### TECHNICAL FIELD

The present invention generally relates to revenue generating intelligent parking systems. More particularly, the present invention relates to utilizing data generated in intelligent parking systems for monitoring parking lots, tracking shopping carts, generating revenue, and monitoring a patron's location.

### BACKGROUND

Commercial parking lots and garages are often times overcrowded and it is difficult to find parking, especially during the holiday season. City streets, malls, and stores are often overcrowded with consumers. Meanwhile, consumers spend a great deal of time searching for parking spaces to park their vehicles. In some instances, consumers have to create their own parking spaces on the outskirts of parking lots, street corners, abandoned lots, etc. Oftentimes, vehicles are blocking driveways, and causing chaos, which can create extra wear and tear on the vehicles. The creation of these make shift parking spaces generates a huge danger and inconvenience for consumers, pedestrians, drivers, and parking lot owners. Furthermore, parking lot owners at malls, grocery stores, and drug stores, for example, rarely gain revenue from consumers parking in parking lots.

Typically, intelligent lighting systems refer to lighting systems that adapt to movement by pedestrians, cyclist, vehicles, and the like. Lighting systems are made intelligent by placing cameras or sensors on light poles, or in the vicinity of the luminaries. Placing sensors and cameras on lighting systems enables the system to detect movement and the presence of objects. In some cases, intelligent lighting systems use computer vision analytics. As understood by those of skill in the art, computer vision analytics includes methods for acquiring, processing, analyzing, and understanding images and, in general, high-dimensional data from the real world to produce numerical or symbolic information.

In intelligent lighting systems and smart cities, sensors are sensing and monitoring the presence of objects and people, the movement of objects and people, as well as the movement of vehicles in parking areas. The sensors collect a plethora of data including; vehicle count, vehicle velocity, vehicle direction of travel, pedestrian count, pedestrian direction of travel, etc. As the sensors are collecting data, they can also determine if a vehicle is parked in a particular parking space or if the parking space is vacant.

There is an overabundance of metadata available via the sensors utilize throughout parking areas. Conventional systems, however, are unable to capitalize on the availability of this metadata. For example, this metadata could be beneficial to mall parking lot owners, city managers, military base personnel etc. Benefits of the data collections include potential revenue streams, increased safety, and accident prevention.

More recently, intelligent systems are designed with the ability to extract data normally difficult to otherwise obtain. Alternative data collection technologies utilize a puck that is placed in asphalt below a parking space. The puck is battery operated and a magnetic field technology determines if the parking space is vacant. This puck technology can be cumbersome to maintain, especially with respect to changing batteries in the puck.

In conventional intelligent systems, for example, sensors can be placed on light poles that are over 30 feet tall, with 50-60 poles in a designated parking area. These intelligent systems can have a ubiquitous coverage of sensor data collected from the parking lot, injected into the sensor data processing system and subsequently into a data storage device or cloud. Intelligent systems generally monitor more information than puck technology. Although, there is an abundance of collected metadata, systems that efficiently commercialize this process continue to be scarce.

### SUMMARY OF THE INVENTION

Given the aforementioned deficiencies, what is needed therefore, are methods and systems that more effectively commercialize the use of metadata produced by intelligent lighting system sensors. For example, methods and systems are needed that facilitates more beneficial use of this metadata in parking systems and for parking lot and garage owners. A need also exists for tier parking systems that provide lot owners with an ability to charge, for example, in accordance with the location of parking spaces. For instance, the closer a space is to a location of interest, the higher its associated parking fee.

Intelligent systems, in accordance with the embodiments, collect and efficiently utilize sensor data related to parking space vacancies and shopping cart locations. This data can also be used to monitor things such as fender/benders, black ice accumulation, handicap parking misuse, theft monitoring, facial detection, etc. In accordance with the embodiments, from a remote storage location, such as the cloud or a remote data storage unit, sensor data can be distributed in a manner useful to the production and collection of revenue.

Embodiments of the present invention, under certain circumstances, provide a parking reservation method including monitoring a parking area, via a sensor, to (i) determine movement within the parking area and (ii) produce movement data representative of the movement. The method also includes analyzing the movement data, via a processor, to create a user alert and transmitting the alert to a user external device.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is an illustration of a standard parking lot.

FIG. 2 is an illustration of a light pole constructed in accordance with an embodiment of the present invention.

FIG. 3 is an illustration of exemplary sensors configured for use in the light pole depicted in FIG. 2, according to the embodiments.

FIG. 4 is an illustration of an intelligent system constructed in accordance with one embodiment of the present invention.

FIG. 5 is an illustration of an intelligent system constructed in accordance with another embodiment of the present invention.

FIG. 6 is an illustration of an external device for communicating information via the embodiments in a first usage scenario.

FIG. 7 is an illustration of an external device for communicating information via the embodiments in a second usage scenario.

### DETAILED DESCRIPTION OF THE EMBODIMENTS

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

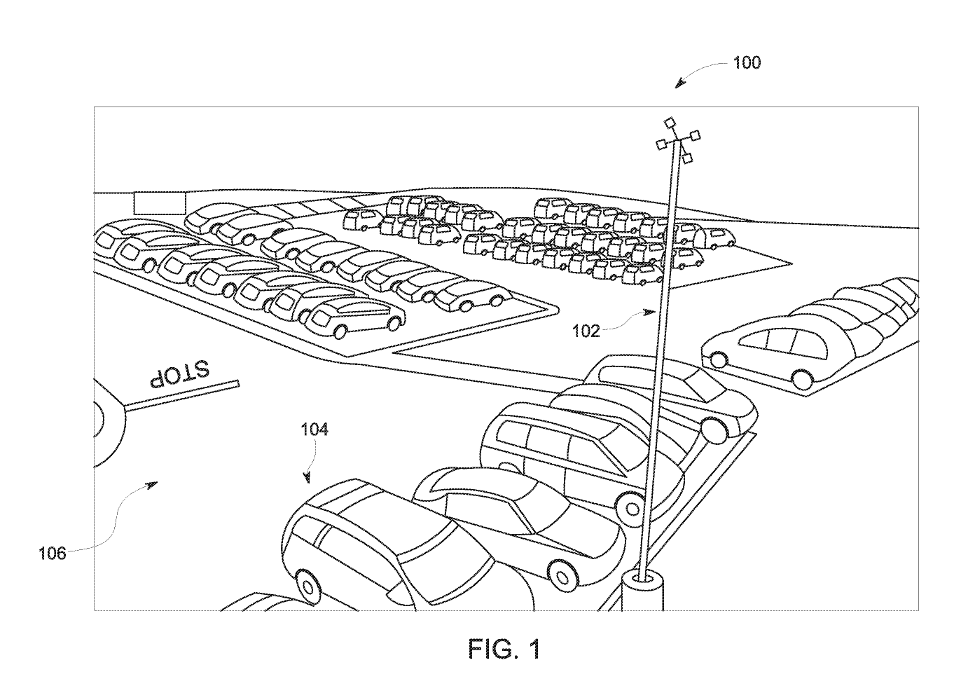

FIG. 1 is a schematic diagram of a standard parking lot 100. As depicted in FIG. 1, the standard parking lot 100 is filled to capacity with vehicles 104, and includes light poles 102, and driveways 106.

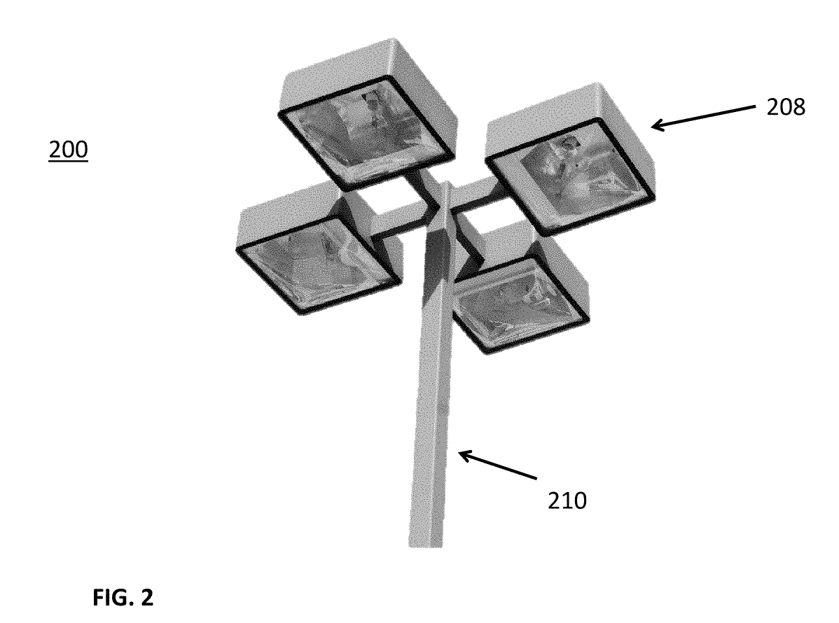

FIG. 2 is a schematic diagram of an exemplary light pole 200, constructed in accordance with an embodiment of the present invention. By way of example, the light poles 102 depicted in FIG. 1, could be replaced by the light pole 200. The light pole 200 includes luminaire 208 and a post 210 for support. The pole 200 can include at least one intelligent sensor to receive data, along with a local or remote data storage medium.

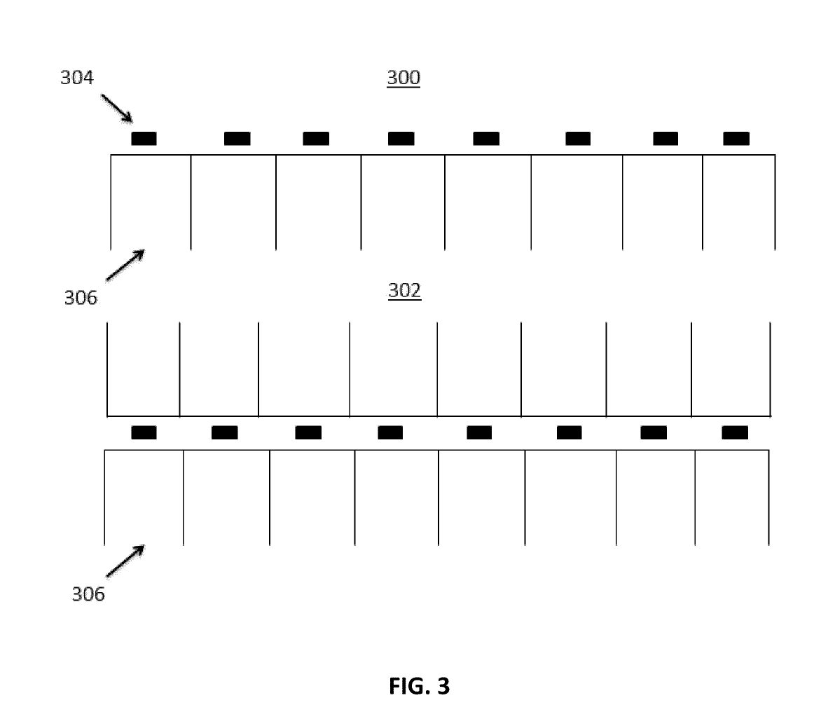

FIG. 3 is an illustration of an intelligent system 300, constructed in accordance with an embodiment of the present invention. The intelligent system 300, deployed in a parking lot 302, includes intelligent sensors 304. The parking lot 302 includes identified parking spaces 306. The sensors 304 are used to determine whether the parking spaces 306 are occupied. Although the illustration of FIG. 3 depicts a one-to-one correspondence between the sensors 304 and the parking spaces 306, in other embodiments, one of the sensors 304 can monitor multiple parking spaces 306.

In the exemplary embodiment of FIG. 3, for example, one of the sensors 304 is placed adjacent to one of the parking spaces 306. For example, the intelligent sensors 304 can be placed on the ground in front of, or in, the parking space, elevated in the vicinity of the parking space, or on a pole or on a building for directing focus on the parking space. The intelligent sensors 304 determine whether the parking space 306 is occupied by a vehicle, a shopping cart, or some other object.

Intelligent sensors 304 may also be placed in the parking lot 300 to monitor driveways, such as the driveways 106, depicted in FIG. 1. The sensors 304 can also monitor other aspects of areas surrounding the parking lot 300. As understood by one of skill in the art, the intelligent sensors 304 could also include a camera for documenting activity in the parking lot 302 and/or the parking spaces 306.

The intelligent sensors and/or cameras 304 can be activated upon detection of motion (or some other suitable trigger) within a defined area, and can record related activity occurring therein. Data collected by the sensors 304 can be processed and used a variety of ways. For example, the collected data can be used to support production and collection of revenue, prevent incidents, or provide data to interested end users.

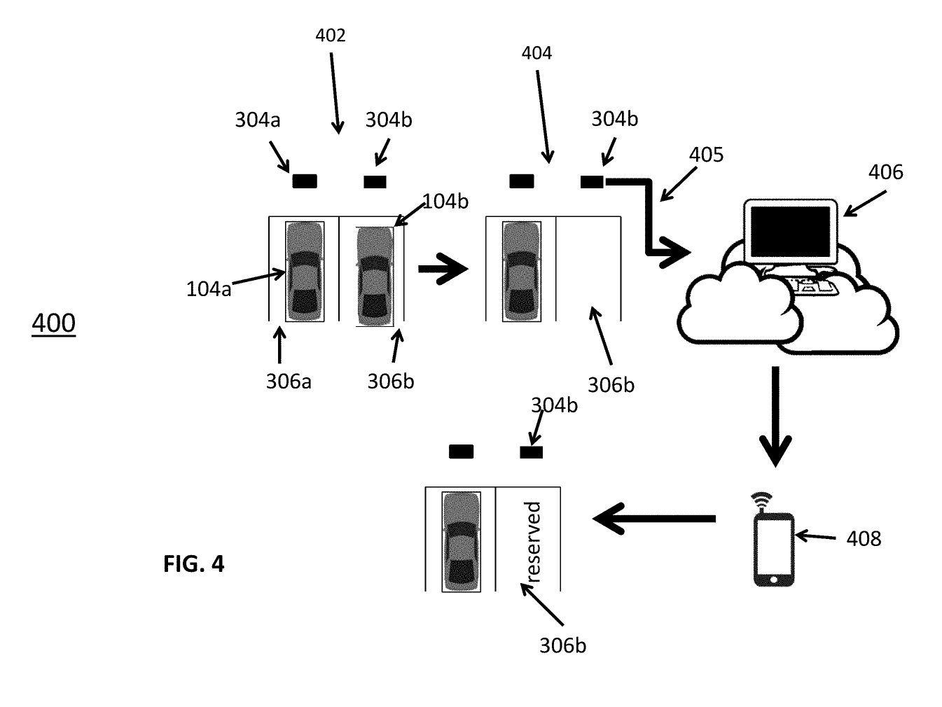

FIG. 4 is an illustration of an intelligent system 400 constructed in accordance with another embodiment of the present invention. The parking system 400 is represented by a parking diagram 402. The parking diagram 402 depicts that parking sensors 304a and 304b are placed in front of parking spaces 306a and 306b, respectively. Vehicles 104a and 104b, featured among vehicles 104 depicted in FIG. 1, are located in parking spaces 306a and 306b, respectively. In the example of FIG. 4, sensors 304a and 304b simultaneously monitor and detect the presence of vehicles 104a and 104b in the parking spaces 306a and 306b, respectively.

Also in FIG. 4, and during another instant in time, a parking diagram 404 illustrates that vehicle 104b no longer occupies parking space 306b, as detected by the sensor 304b. Upon detection that the parking space 306B is vacant, the sensor 304b transmits, via network 405, a signal to a cloud-based computer system 406, including a processor and a memory, denoting that parking space 306b is vacant. The cloud based computer system 406, in turn, transmits information to an external device 408 that alerts a user of the vacancy.

By way of example, the user can reserve the vacant parking space 306b via the external device 408. The user may have to submit a payment to reserve the parking space 306B via the external device 408. If the user reserves the vacant parking space 306b, a signal can be transmitted to other users communicating the reservation.

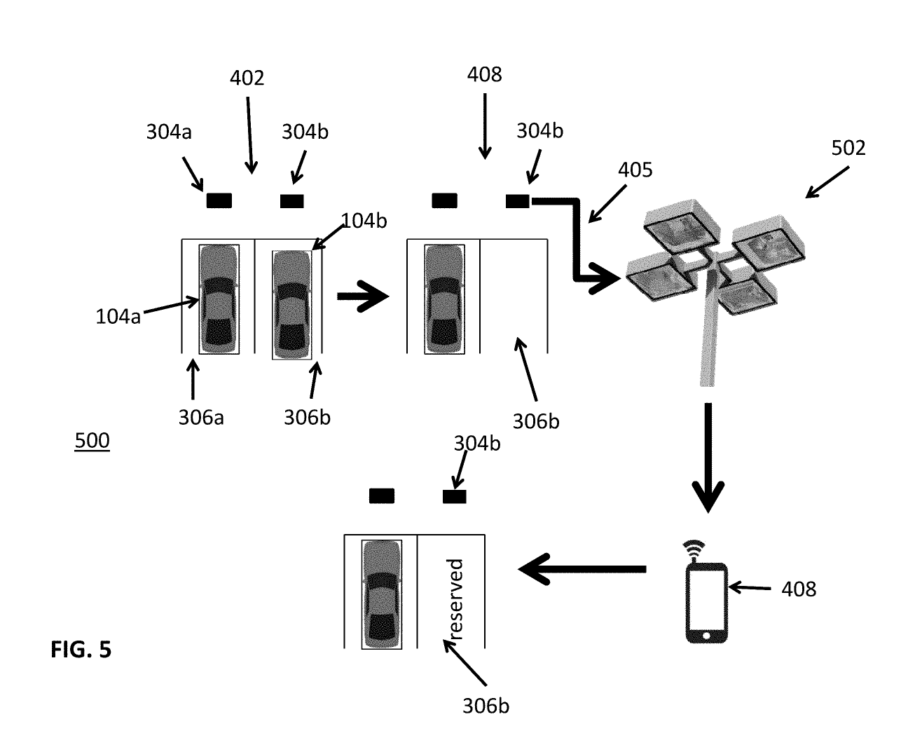

FIG. 5 is an illustration of an intelligent system 500 constructed in accordance with the embodiments. Parking diagram 402 illustrates parking sensors 304a and 304b placed in front of parking spaces 306a and 306b, respectively. Vehicles 104a and 104b are parked in spaces 306a and 306b, respectfully, as detected by sensors 304a and 304b.

At a different instant in time, parking diagram 404 illustrates that vehicle 104b no longer occupies parking space 306b. Subsequently, the sensor 304b detects that the parking space 306b is vacant and transmits a signal. The signal is transmitted to a processor, for example, within the light pole 502 communicating the vacancy. The processor instantly transmits information to the external device 408 alerting a user that the parking space 306b is vacant. As in the case of the system 400 of FIG. 4, the user can reserve the vacant parking space 306b via the external device 408.

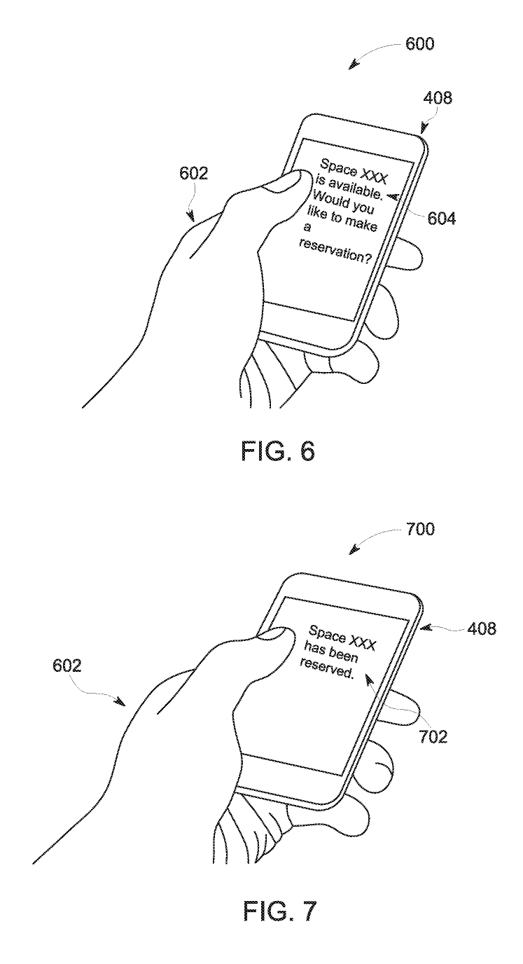

FIG. 6 is an illustration 600 of an exemplary external device 422 for communicating information via an embodiment in a first usage scenario. In FIG. 6, the external device 422 sends an alert 602 to a user 604 as notification of a vacant parking space, for reservation.

FIG. 7 is an illustration 700 of the exemplary external device 422 communicating information, via an embodiment in a second usage scenario. In FIG. 7, the external device 422 sends an alert 702 to the user 604 that the parking space has been reserved by another user. Once the user 604 has parked their vehicle in the reserved parking space 306b, the sensor can be configured to monitor other activity there within.

In the embodiments, the sensors 304 may monitor movement within the parking spaces and alert the user of any activity including vehicle, other objects, and human movement. As noted above, the sensor may also be equipped with a camera for recording the activity.

In another embodiment, the intelligent sensor 304 monitors for loose shopping carts and objects in a parking lot. The intelligent sensor system alerts a user of the object's location. The intelligent sensor 304 can monitor parking space 306, driveways 106, and other areas of the parking lot 300 for shopping carts.

In the embodiments, the user can receive various alerts or have the ability access a real-time view of the parking lot. The alerts can be generated through a computer or mobile device application. By way of example, the computer or mobile device application can send a fault alert to the user identifying any issues. Once the issues are addressed, the fault can be cleared in the application.

In yet another embodiment, the intelligent sensors 304 monitor the parking lot 300 for hit and runs, minor fender benders, collisions, close encounters, and the like. The sensor 304 may activate a recording device after the detection of an incident for processing and storing the data, produced by the activity, in the cloud based computer system 406. This date, collected from the recording device, could be retrieved at a later time as needed, for example, by customers, insurance companies, law enforcement, and similar agencies or entities.

In another embodiment of the invention, the intelligent sensors can monitor users and communicate with the user via an application. By way of example, the application can alert the users of real time special offers in the nearby area.

In the embodiments, the alert to the user can be via a text message alert, mobile device application, web application alert, email alert, etc. The alerts sent to the users can be configured for real time, delayed, or programmable transmission to the users.

In the embodiments, the sensor 304 can be replaced with a computer vision analytics device. The sensor or computer vision analytics device 304 can be placed on a pole, a wall, on the ground, or similar. The sensor or computer vision analytics device 304 can be connected to any type of network including but not limited to Wi-Fi, local area networks, wide area networks, cellular networks, or other. The data transmitted from the sensor, or computer vision analytics device 304, may be used in some capacity to charge the user for using the information.

Other end user benefits of the intelligent system cans include monitoring cars to determine if the car's headlights have been left on, monitoring handicapped parking spaces and issuing fees to violators of the parking space, monitoring theft, assisting end users to recall where the end user parked his or her vehicle, controlling lights and energy, facial recognition, and many more.

In alternative embodiments, the invention may be configured to assist end users generate revenue, reduce cost, and/or assist in the wellbeing of store owners and consumers. The sensors 304 would monitor the parking area and communicate to the external device 406/408 the appropriate data to assist in either generating revenue, reducing cost, and/or increasing the consumers/citizens/store owner's well being.

For example, the sensors may be used to monitor parking spaces and driveways for loose shopping carts. Consumers and/or store owners may be charged. The consumers may be charged a fine for leaving the carts in a non-designated space. Store owners may be charged for the retrieval of the loose shopping carts.

In another example, the sensors may monitor the area for fender benders and hit and run accidents. The system would enable consumers and insurance companies reduce cost of minor accidents, fender benders, and hit and run accidents. The system would enable consumers and end users pinpoint the exact cause of the accident.

Additionally, the system may be used to monitor the accumulation of black ice. Monitoring the accumulation of black ice both generate revenue for business owners and reduce cost to the consumers. Revenue may be generated by companies that treat parking lots and roadways for ice accumulation. The system would help prevent consumer automobile accidents and personal injury of the consumers and therefore reducing cost.

The system may also may also be used to monitor vehicles to determine if headlights have been left on. The system may reduce cost to the consumers by eliminating the need to replace car batteries. The system may also be used to generate revenue for entities such as AAA® (car emergency services).

Additionally, the system may be used to generate revenue for the misuse of handicapped spaces. Displaying the number of vacate spots in a parking area may also be used by the system to generate revenue. The system may also be used to monitor theft in parking areas. The would help both consumers and insurance companies reduce cost. The system can also be used to distribute coupons to end users for stores adjacent to the end user, this would help generate revenue and reduce consumer cost.

Further still, embodiments of the present invention may also be used in facial detection. This could be used by law enforcement, and/or via social media applications such as Facebook®, Instagram®, where facial detection can assist in protecting the consumer's well-being. The embodiments are also not restricted to parking lot applications and can be useful in any geography-based detection or reservation systems.

Alternative embodiments, examples, and modifications which would still be encompassed by the disclosure may be made by those skilled in the art, particularly in light of the foregoing teachings. Further, it should be understood that the terminology used to describe the disclosure is intended to be in the nature of words of description rather than of limitation.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

What is claimed is:

1. A parking reservation method comprising:
monitoring a parking area, via a sensor, to (i) determine movement within the parking area and (ii) produce movement data representative of the movement;
analyzing the movement data, via a processor, to create a user alert; and
transmitting the alert to a user external device.

2. The parking reservation method of claim 1, further comprising:
alerting an end user of the data point;
reserving the defined area using the external device; and
generating revenue from the reservation of the defined area.

3. The parking reservation method of claim 1, wherein the movement data is transmitted to the processor via a network.

4. The parking reservation method of claim 1, wherein another sensor monitors movement in another parking area.

5. The parking reservation method of claim 4, wherein the sensor and the other sensor are integrated together.

6. The parking reservation method of claim 5, wherein the sensor and the other sensor are configured to respectively monitor the parking area and the other parking area, substantially simultaneously.

7. The parking reservation method of claim 1, wherein the movement data is associated with revenue generation.

8. A computer readable media storing instructions wherein said instructions when executed are configured to perform a method for managing a parking area, comprising:
monitoring the parking area, via a sensor, to (i) determine movement within the parking area and (ii) produce movement data representative of the movement;
analyzing the movement data, via a processor, to create a user alert.

9. The computer readable media of claim 8, further comprising:
alerting an end user of the data point;
reserving the defined area using the external device; and
generating revenue from the reservation of the defined area.

10. The computer readable media of claim 9, wherein the movement data is transmitted to the processor via a network.

11. The computer readable media of claim 10, wherein another sensor monitors movement in another parking area.

12. The computer readable media of claim 11, wherein the sensor and the other sensor are integrated together.

13. The computer readable media of claim 8, wherein the sensor monitors for abandoned shopping carts and the user alert transmits the abandonment to the user external device.

14. The computer readable media of claim 8, wherein the sensor monitors for hit and run accidents, while the sensor records the accident.

15. The computer readable media of claim 14, wherein the recording is stored in the user external device.

16. The computer readable media of claim 8, wherein the sensor monitors for snow accumulation and black ice and the user alert transmits the accumulation to the user external device.

17. A parking reservation system, comprising:
a sensor configured to (i) detect status data responsive to an identified parking area and (ii) transmit the status data;
a processor configured to analyze the transmitted status data to produce an alert;
an external device system configured to communicate the alert to a user.

18. A geography-based reservation method comprising:
monitoring a designated geographic area, via a sensor, to (i) determine movement within the geographic area and (ii) produce movement data representative of the movement;
analyzing the movement data, via a processor, to create a user alert; and
transmitting the alert to a user external device.
